(19) United States
(12) Patent Application Publication
(10) Pub. No.: US 2001/0032701 A1
(43) Pub. Date: Oct. 25, 2001

(54) Wave absorber and production method thereof

(76) Inventors: Teruaki Kawanaka, Yamato-shi (JP); Eiichi Oohira, Yamato-shi (JP); Toshio Kudo, Osaka-shi (JP); Takahiro Kariya, Arida-shi (JP); Takayoshi Mitsui, Arida-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/814,195

(22) Filed: Mar. 21, 2001

(30) Foreign Application Priority Data
Mar. 23, 2000 (JP) 82744/2000

(51) Int. Cl. H01Q 17/00

(52) U.S. Cl. 156/276; 342/4

(57) ABSTRACT

A method for producing a wave absorber, which method includes rubbing a mixture of a solidifiable fluid binder and a particulate dielectric loss material on a substrate and solidifying the binder, thereby to laminate a wave absorptive layer on the substrate, and a wave absorber produced by this production method are provided. According to the production method of the present invention, a structure including a dielectric loss material and a binder admixed most preferably for wave absorption can be formed easily into a long sheet or a long belt-like wave absorber.

### FIELD OF THE INVENTION

The present invention relates to a wave absorber and a production method thereof.

### BACKGROUND OF THE INVENTION

A conventional wave absorber is known to be made by forming a mixture of a binder, such as a rubber, plastics and the like, and a dielectric loss material, such as a graphite powder, a ferrite powder and the like, by press forming and the like into a pyramidal, a wedge, a belt-like or a sheet wave absorber. When a particularly long belt-like or sheet wave absorber is desired, the above-mentioned mixture is generally subjected to extrusion forming or sheet forming using two rolls.

A wave absorber characteristically has a multi-layer structure for efficient absorption of a broadband electric wave. The above-mentioned extrusion forming enables production of a sheet wave absorber from the aforementioned mixture, but has a difficulty in forming a multi-layer structure. Conventionally, it is difficult to produce a sheet or belt, particularly long sheet or long belt, wave absorber having sufficient wave absorption property.

In view of the above-mentioned situation, the present invention aims at solving the above-mentioned problems, and providing a production method capable of easy forming of a long sheet or long belt wave absorber comprising a dielectric loss material and a binder admixed most preferably for wave absorption, as well as a preferable wave absorber produced by this production method.

### SUMMARY OF THE INVENTION

In accordance with the present invention, there is now provided a wave absorber comprising a substrate and a wave absorptive layer comprising a binder and a particulate dielectric loss material, wherein said layer is formed on the substrate by rubbing a mixture of the particulate dielectric loss material and the binder in a solidifiable fluid state, and solidifying the binder. The above-mentioned mixture is preferably rubbed on the substrate via an adhesive layer.

The substrate surface on which the above-mentioned mixture is rubbed is preferably about planar.

Preferably, a convex and/or a concave that may penetrate the substrate are/is formed on and/or in the substrate on which the above-mentioned mixture is rubbed, and the mixture is rubbed into the aforementioned concave or to cover the convex.

It is preferable that the above-mentioned mixture be rubbed on the substrate in not less than two layers, thereby forming a structure comprising two or more wave absorptive layers laminated on the substrate, and the kind of the dielectric loss material or the mixing ratio of the dielectric loss materials is determined such that the surface resistance of the wave absorptive layer on the lower layer side can be lower than it is of the wave absorptive layer on the upper layer side.

It is also preferable that the above-mentioned wave absorptive layer have a convex on its surface and/or a concave therein.

The wave absorber of the present invention has a structure consisting of a substrate and a wave absorptive layer laminated on the substrate, which layer comprising a particulate dielectric loss material fixed by a binder, wherein the substrate has a convex capable of holding the wave absorptive layer and suppressing release thereof and/or a concave that may penetrate the substrate, and the wave absorptive layer and the aforementioned convex and/or the concave are engaged with each other such that release from each other is suppressed.

The present invention moreover provides a method for producing a wave absorber, which method comprises rubbing a mixture of a solidifiable fluid binder and a particulate dielectric loss material on a substrate and solidifying the binder, thereby to laminate a wave absorptive layer on the substrate. The above-mentioned substrate is preferably a long belt-like plate.

### BREIEF DESCRIPTION OF THE DRAWINGS

FIG. 1 is a simplified cross section showing the wave absorber of a particularly preferable embodiment of the present invention.

FIG. 2 is a simplified cross section showing the wave absorber of another preferable embodiment of the present invention.

FIG. 3 is a simplified cross section showing the wave absorber of a yet another preferable embodiment of the present invention, wherein FIG. 3(a) is a front view and FIG. 3(b) is a top view.

### DETAILED DESCRIPTION OF THE INVENTION

The wave absorber of the present invention basically comprises a substrate and a wave absorptive layer laminated on the substrate. In this specification, the side, where an electric wave enters, relative to the substrate (the side on which a wave absorptive layer is laminated), is considered an “upper side” and the upper-lower direction is considered to be present along the direction of lamination.

According to the production method of the wave absorber of the present invention, a mixture of a solidifiable fluid binder and a particulate dielectric loss material is prepared in the first step. The production method of this mixture is not particularly limited, and a conventionally known apparatus, such as roll mill, henschel mixer, mixing roll, Banbury mixer, pressure kneader and the like, is appropriately selected and used according to the amount of the mixture to be produced, a mixing ratio of the binder and the dielectric loss material, and the like.

In the next step, the above-mentioned mixture produced is rubbed on the substrate. By the “rubbed” is meant in this specification, coating while applying a pressure of 100-1000 kgf/cm², preferably 200-500 kgf/cm². The apparatus used for the rubbing, in other words, application with pressurization, temperature conditions and the like are not particularly limited. For example, the substrate and the mixture are supplied between two rolls to allow the mixture to be gradually gripped by the substrate, whereby the mixture is rubbed on the substrate surface. The temperature conditions during the rubbing are not particularly limited and the rubbing is performed at, for example, room temperature (25C.).

When a wave absorber comprising an adhesive layer between the substrate and the wave absorptive layer is to be produced, an adhesive is previously applied to the aforementioned substrate surface, the adhesive is dried to form an adhesive layer, and the aforementioned mixture is rubbed on the adhesive layer. The method for forming the above-mentioned adhesive layer is not particularly limited, and may be a conventionally known method. The mixture is rubbed not only on a substrate surface, but any part if it is on the upper side of the substrate.

In the subsequent step, the binder in the mixture rubbed on the substrate is solidified to form a wave absorptive layer laminated on the substrate. The solidification of the binder in this step includes, for example, passing the mixture rubbed on the substrate as mentioned above through a heating furnace, to allow crosslinking reaction or vulcanizing reaction of the binder in the mixture. The above-mentioned heating furnace is heated by a method using electricity, gas, steam and the like, wherein the heating conditions are specifically determined from the heating temperature and heating time generally employed for crosslinking or vulcanizing. For example, heating temperature of 120-250° C. and heating time of 3-60 min are employed. Alternatively, the binder may be passed through the above-mentioned heating furnace to allow evaporation of the volatile components in the binder, thereby solidifying the binder. In this case, the heating conditions are determined in the same manner as in the above-mentioned cases. The heating temperature for the solidification of the binder is, for example, preferably about 150° C. According to the production method including these steps, a wave absorber having a single wave absorptive layer can be produced.

When a wave absorber having two or more wave absorptive layers (to be mentioned later) is to be produced, the rubbing step, or the rubbing and solidification step, is repeated. That is, for example, a mixture having a different mixing ratio and the like of the binder and the dielectric loss material is rubbed on a first wave absorptive layer, and a second wave absorptive layer and the following absorptive layers are laminated. The solidification to give each wave absorptive layer may be performed every time the layer is formed, or may be performed at once after complete lamination. By rubbing two or more layers of the mixture on the substrate, a wave absorber having a structure, wherein two or more layers are laminated on the substrate, is produced as mentioned below. The number of layers of the laminate is appropriately determined according to the objective wave absorption property. In the present invention, the mode of rubbing is not limited to the above-mentioned, as long as the mixture can be rubbed in substantially two or more layers on the substrate.

By producing a wave absorber according to this method, a single-layer or multi-layer long sheet or long belt wave absorber having suitable wave absorption property can be produced easily, because the mixture can be held by the substrate even if the content of the binder is reduced and the content of the dielectric loss material is increased in the production of the mixture. Moreover, because the aforementioned mixture is rubbed on the substrate, the strength, elongation and the like of the mixture before solidification need not be considered, unlike production of a wave absorptive layer by the conventional extrusion forming or sheet forming. Consequently, a high-grade long wave absorber can be produced at a lower cost than it is by a conventional method. The wave absorber obtained by such production method has a wave absorptive layer formed by rubbing a mixture containing the above-mentioned solidifiable fluid binder and a particulate dielectric loss material on the substrate, and solidifying the binder.

The outer shape of the substrate of the wave absorber of the present invention is not particularly limited as long as the wave absorptive layer can be carried thereon, but it is preferably a sheet or a belt, more preferably a long sheet or a long belt. When the substrate is a long belt, a through process becomes possible, which includes re-winding a roller, around which the belt-like substrate has been wound, to deliver the substrate, subjecting the substrate to each step for forming a wave absorptive layer, and winding the substrate on a roller as a wave absorber. The thickness of the substrate is not limited, but it is about 0.02 - 2.0 mm, preferably about 0.05 - 0.5 mm.

The material of the substrate is not particularly limited, but it is preferably a metal plate of, for example, iron, SUS, copper, brass, nickel, zinc-plated iron and the like, polymer film of, for example, polyester, polyimide and the like, cloth, paper and composite thereof and the like. The above-mentioned metal plate, which reflects the electric wave, is particularly preferable. The substrate may be a mesh. For example, Metal Lath such as expand metal and punching metal having an opening ratio of about 20 - 60% or a metal plate processed into a mesh may be used. For an improved weatherability (corrosion resistance) of the substrate, particularly an SUS plate, from among the above-mentioned metal plates, is preferably used.

The binder is not particularly limited as long as it has fluidity and is solidifiable, but it is preferably rubber latex such as NBR (nitrile rubber) latex, SBR (styrene-butadiene rubber) latex, chloroprene rubber latex and the like. Such binder in the above-mentioned production method enables rubbing of the mixture on the substrate, forming of a wave absorptive layer by solidification, and fixing of the dielectric loss material in the wave absorptive layer. The mixture has a solid content of preferably 30 - 1000 parts by weight, particularly 50 - 800 parts by weight, per 100 parts by weight of the binder. The mixture is produced by adding, for example, 500 parts by weight of talc, 200 parts by weight of carbon, and about 0.1 part by weight of a processing aid and a vulcanizing agent, per 100 parts by weight of the binder.

The dielectric loss material is not particularly limited as long as it is particulate and shows an action to attenuate the electric wave to be absorbed by causing a loss, such as dielectric loss, conduction loss, magnetic loss and the like. Examples of such dielectric loss material preferably include carbon, graphite, ferrite and the like. These dielectric loss materials can be used alone or in an appropriate combination. These dielectric loss materials are preferably dispersed thoroughly during the mixing stage before rubbing on a substrate, so that they are sufficiently dispersed in the wave absorptive layer to be formed.

The mixing ratio of the above-mentioned binder and the dielectric loss material is appropriately determined according to the surface resistance to be mentioned later. When the wave absorber of the present invention has a single layer of the wave absorptive layer, it is preferable that 20 - 250 parts by weight, more preferably 40 - 220 parts by weight, of a dielectric loss material be mixed with 100 parts by weight of the binder. When the above-mentioned mixing ratio is less than 20 parts by weight of the dielectric loss material per 100 parts by weight of the binder, the wave absorber cannot exhibit sufficient wave absorption property, and conversely, when more than 250 parts by weight of the dielectric loss material is used per 100 parts by weight of the binder, a wave absorptive layer cannot be cured sufficiently by the solidification of the binder, and the electric wave may be undesirably reflected.

According to the present invention, a wave absorber that a conventional production method has failed to realize can be produced, which comprises a single wave absorptive layer having a mixing ratio of 200- 250 parts by weight of a dielectric loss material per 100 parts by weight of the binder. As a result, a high grade long sheet or belt-like wave absorber can be produced, which has a single wave absorptive layer, and which exhibits wave absorption property superior to that of a single layer wave absorber produced by a conventional production method.

When the wave absorptive layer is a single layer in the present invention, the surface resistance of this wave absorptive layer as a whole is preferably about 1 kΩ- 1 MΩ, particularly 5 kΩ- 500 kΩ. The kind of the dielectric loss material and other additives, and the mixing ratio of these and binders are preferably determined as appropriate to make the surface resistance fall within the above-mentioned range.

The wave absorptive layer of the wave absorber of the present invention having the above-mentioned single layer is so formed as to have the thickness, along the thickness direction of the aforementioned substrate, of preferably 0.2 - 3.0 mm, more preferably 0.5 - 2.0 mm. When the above-mentioned thickness is less than 0.2 mm, a sufficient wave absorption effect is not obtained. Conversely, when the above-mentioned thickness exceeds 3.0 mm, the wavelength range to be used, particularly the high frequency band over the GHz band, cannot be set easily.

The aforementioned mixture may be rubbed on the substrate via an adhesive layer. In other words, the wave absorber of the present invention may have an adhesive layer between the substrate and the wave absorptive layer. For the adhesive layer to be formed, an adhesive is applied to the substrate surface in advance before forming the aforementioned wave absorptive layer. Examples of the adhesive preferably include epoxy resin, phenol resin, chloroprene rubber, mixtures thereof and the like, with particular preference given to epoxy resin. The presence of an adhesive layer between the substrate and the wave absorptive layer enables improvement in the adhesive property between the substrate and the wave absorptive layer, which in turn realizes a wave absorber wherein the substrate and the wave absorptive layer are far less frequently released as compared to a structure without the aforementioned adhesive layer.

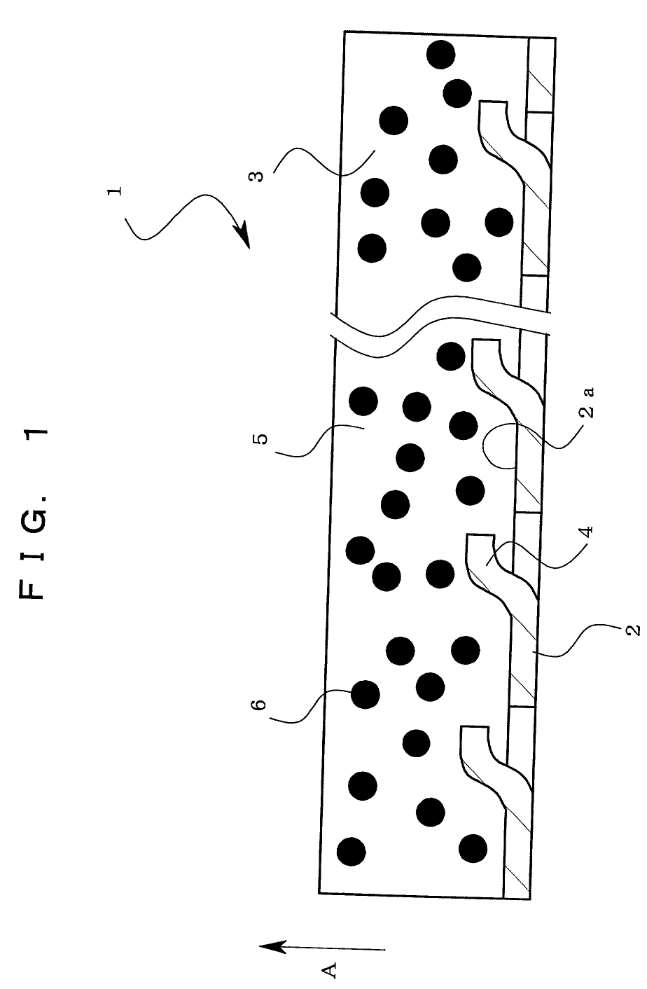

The preferable mode of the substrate includes one wherein a convex and/or a concave that may penetrate the substrate are/is formed on/in the substrate surface. The concave includes a hollow and a through hole. The substrate on/in which a convex and/or a concave are/is formed can be obtained by, for example, hook processing (convex) as shown in FIG. 1, punching processing (concave), expand processing and the like of the above-mentioned metal plate. When a wave absorber having such substrate is to be produced, the aforementioned mixture is rubbed so that it covers a convex formed on the above-mentioned substrate surface and/or enters a concave formed in the above-mentioned substrate surface and preferably fills the concave. The shape of the above-mentioned convex and concave formed on or in the above-mentioned substrate surface is not limited, but the shape preferably prevents coming off of the wave absorptive layer. For example, the convex may be a hook, an arc, a mushroom, or a protrusion with a return and the like, and the concave may be a simple through hole (the wave absorptive layer that reached the back side makes coming off unfeasible), a through hole tapered toward the back side, a shape having a dovetail groove cross section and the like.

A simplified cross section of a particularly preferable embodiment of the wave absorber of the present invention is shown in FIG. 1. The wave absorber 1 shown in FIG. 1 corresponds to the embodiment wherein a convex and/or a concave are/or formed on and/or in the substrate surface, and the mixture is rubbed into the concave and/or to cover the convex. The wave absorber 1 has a substrate 2, and a wave absorptive layer 3 laminated on the substrate 2. The substrate 2 has a wave absorptive layer 3 on an upper surface 2a on the upper side thereof and has plural convexes 4 that have a shape capable of suppressing the release of the substrate 2 from the wave absorptive layer 3. Each convex 4 protrudes from the upper side A of the substrate 2 and is formed like, for example, a hook.

The wave absorptive layer 3 comprises a solidified binder 5 and a particulate dielectric loss material 6 fixed in the binder 5 in a generally uniformly dispersed state. The wave absorptive layer 3 is formed on the upper side A of the substrate 2 to cover each convex 4, and gears with each convex 4. As a result, the substrate 2 and the wave absorptive layer 3 strongly holds on to each other, making release of the substrate 2 from the wave absorptive layer 3 unfeasible. This has a consequence that a long sheet or long belt-like wave absorber capable of stably retaining the high quality can be prepared. The production method of this wave absorber is not limited, but it is most preferably formed according to the above-mentioned production method of the present invention.

It may be a wave absorber wherein an adhesive layer is formed between the substrate and the wave absorptive layer, the above-mentioned convex and/or concave are/is formed on/in the surface of the substrate abutting the adhesive layer like a gear structure, thereby suppressing the release of the convex and/or concave from the adhesive layer.

As mentioned above, a convex and/or a concave that may penetrate the substrate are/is preferably formed on/in the substrate surface in the present invention. When the wave absorptive layer can be fully supported by the substrate even without such convex and/or concave, the substrate surface may be about planar.

Alternatively, the wave absorber of the present invention may have a structure wherein two or more wave absorptive layers are laminated on the substrate by rubbing the mixture into the substrate in two or more layers. When the wave absorber has such structure, it is formed in such a manner that the surface resistance of the wave absorptive layer on the lower layer side becomes lower than it is of the wave absorptive layer on the upper layer side. In other words, each wave absorptive layer is formed so that the surface resistance of the wave absorptive layer can increase from the substrate side to the electric wave entry side.

A wave absorber having two or more wave absorptive layers so formed that the surface resistance of the wave absorptive layer on the lower layer side can be lower than it is of the wave absorptive layer on the upper layer side is preferable, because it enables more preferable entry of the electric wave from the uppermost surface, and the electric wave is absorbed more in the inside of the wave absorptive layer. The varying surface resistance of respective wave absorptive layers can be realized by, for example, changing the mixing ratio of the dielectric loss material of each wave absorptive layer. In this case, a mixture having a decreased ratio of the binder and containing a great amount of a dielectric loss material is used for the wave absorptive layer on the lower layer side or the substrate side. According to the production method of the present invention, the use of such mixture to form a wave absorptive layer on the substrate is free of any problem in the forming property, unlike the conventional wave absorbers. Therefore, a wave absorber having two or more wave absorptive layers, which satisfies the above-mentioned conditions, can be produced easily. In addition, the kind of the dielectric loss material may be changed for each wave absorptive layer for this end. The number of the wave absorptive layers to be laminated and the upper limit of the thickness of the entire layer are not particularly limited.

When carbon alone is used as the above-mentioned dielectric loss material, the surface resistance of the wave absorptive layer may become generally too low. Where appropriate, the aforementioned mixture in the present invention may contain, besides the dielectric loss material and the binder, a resistance adjusting agent to improve the dispersibility of the above-mentioned dielectric loss material and to make the above-mentioned surface resistance superior. Examples of the aforementioned resistance adjusting agent include fibers such as Wollastonite, sepiolite, glass fiber etc., talc, pulp and the like.

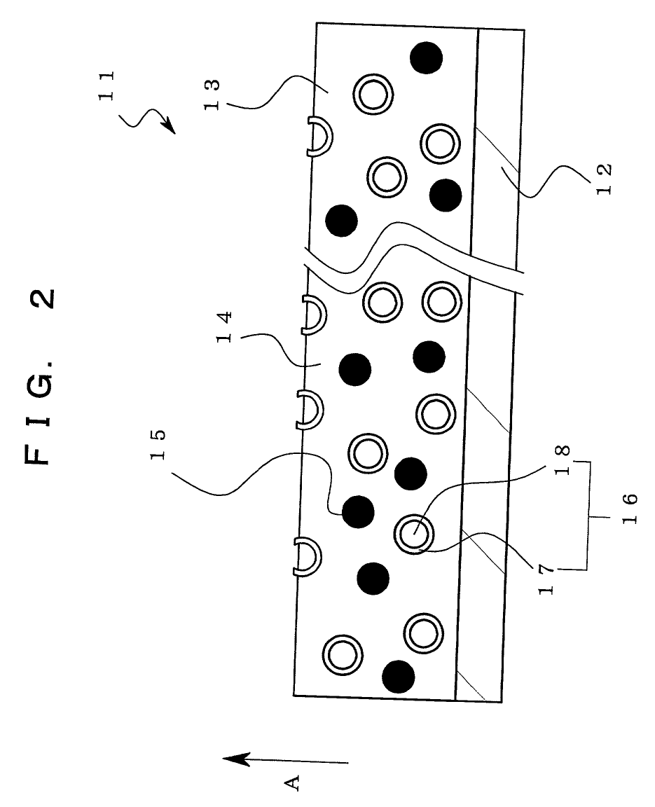

The aforementioned mixture may contain, where appropriate, a void-forming agent as a filler to decrease the dielectric constant of the mixture and to improve the wave absorption property. Examples of the void-forming agent include inorganic products such as Shirasu Balloon having an SiO₂ content of about 75%, hollow glass beads etc., foam plastic sponge, cork and the like. FIG. 2 schematically shows when such a void-forming agent is added.

FIG. 2 is a simplified cross section showing the wave absorber 11 of another preferable embodiment of the present invention. The wave absorber 11 shown in FIG. 2 has a substrate 12 and a single wave absorptive layer 13 laminated on the substrate 12. The wave absorptive layer 13 contains a binder 14 and a particulate dielectric loss material 15 fixed in a generally uniformly dispersed state in the binder 14. A mixture of the binder and dielectric loss material is rubbed on the substrate and solidified. The wave absorptive layer 13 contains a void-forming agent 16 fixed in a generally uniformly dispersed state in the binder 14. The void-forming agent 16 basically contains a hollow covering part 17 and a space 18 encapsulated in the covering part 17. By the addition of such void-forming agent 16 to the wave absorptive layer 13, the dielectric loss material 15 is dispersed better in the wave absorptive layer 13, as compared to the non-use of a void-forming agent 16.

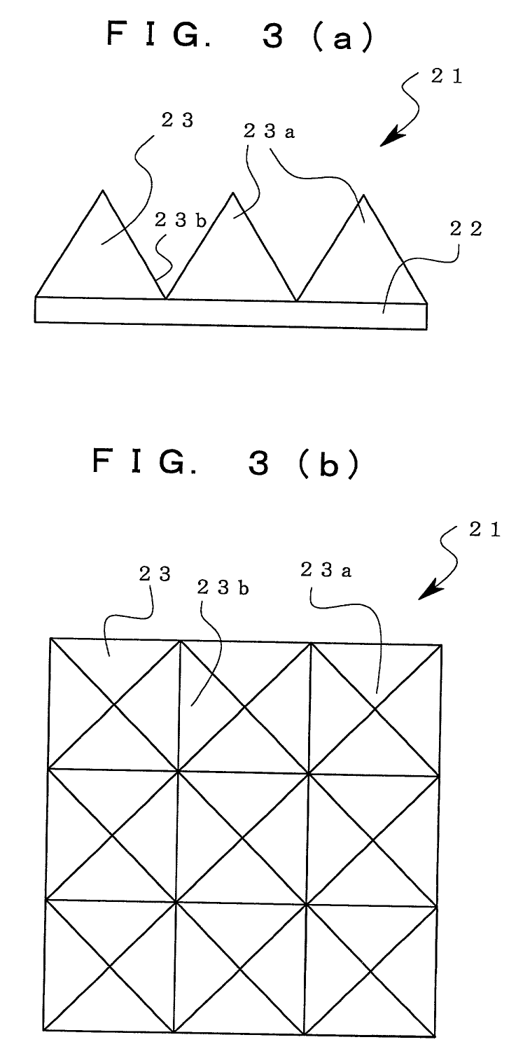

The wave absorber of the present invention may contain a wave absorptive layer having a convex and/or a concave on/in the surface thereof. The shape of the convex and/or concave is not particularly limited. It is preferable that the convex and/or concave are/is formed by at least one of triangular pyramidal, quadrangular pyramidal, hexangular pyramidal and conical protrusions and recesses. FIG. 3 shows a simplified cross section showing the wave absorber 21 of a yet another preferable embodiment of the present invention, wherein FIG. 3(a) is a front view and FIG. 3(b) is a top view. The wave absorber 21 includes a substrate 22 and a wave absorptive layer 23 laminated on the substrate 22, which layer comprises a mixture of a fluid binder and a particulate dielectric loss material rubbed thereon and solidified. FIG. 3 shows an embodiment where the wave absorptive layer 23 has sequential pyramidal protrusions, including convexes 23a and concaves 23b.

The surface of the wave absorptive layer has a convex and/or a concave. This obliterates the restriction on thickness, unlike a wave absorber having an almost flat surface of a wave absorptive layer, and affords a wave absorber having superior properties over a broadband. To be specific, when a wave absorber is used for a wave having a high frequency, particularly of a millimeter wavelength band, and when it is a resonance type wave absorber having an almost flat surface of the wave absorptive layer, the thickness thereof needs to be controlled in a several micron order depending on the wavelength of the electric wave to be absorbed, thus increasing limitations on the production. For example, when a wavelength of 76 GHz is to be absorbed, the thickness of the wave absorptive layer suitable for this frequency is 230 μm, and the precision thereof needs to be ±5 μm. The wave absorber of the present invention may be made to have a wave absorptive layer having a convex and/or a concave on/in the surface thereof, as mentioned above, which embodiment requires less thickness precision.

The height of the convex (straight line distance from substrate surface to the point farthest from the substrate surface) or the depth of the concave is preferably ½- ¼ the wavelength of the electric wave to be absorbed. Specifically, when absorption of an electric wave (wavelength: 3.95 mm) having a wavelength of 76 GHz is intended, the height of the aforementioned convex and the depth of the concave is preferably about 1 - 2 mm.

The method for forming a convex and/or a concave on/in the surface of the wave absorptive layer is not particularly limited, and can be a processing method conventionally used in this field. For example, a method comprising passing a wave absorptive layer, which is obtained by rubbing the aforementioned mixture and solidifying the binder as mentioned above, through an embossed roll or subjecting the wave absorptive layer to a press process with embossing.

The wave absorber of the present invention may further comprise a corrosion-resistant coating or a weatherproof film on its surface to improve weatherability.

The present invention is explained in more detail in the following by referring to an example. The present invention is not limited by the following example.

### EXAMPLE 1

| | | |
|---|---|---|
| binder | 100 | parts by weight |
| dielectric loss material | 60 | parts by weight |
| filler | 87 | parts by weight |
| vulcanizing agent | 4 | parts by weight |
| processing aid | 0.5 | part by weight |
| solvent | 99 | parts by weight |

A composition containing the above-mentioned ingredients was kneaded in a mixer and rubbed (application with pressurization at 300 kgf/cm²) on a thin iron plate having a flat surface (substrate thickness: 0.2 mm), after which it was heated at 150° C. for 1 hr to solidify the binder, whereby a wave absorber of the present invention was produced. The wave absorptive layer formed had a thickness of 0.24 mm. Nitrile rubber latex was used as the binder, a graphite powder was used as the dielectric loss material and talc was used as the filler.

The obtained wave absorber was measured for return loss at 76 GHz by reflex electric power method. As a result, the loss was 34 dB, which was fine. The complex permittivity of the composition of this example at 76 GHz was measured by Free-space method for reference. As a result, that of the real number part was 17.7, and that of the imaginary part was 5.21.

As mentioned above, according to the present invention, a production method capable of easily affording a sheet or belt-like wave absorber, particularly a long wave absorber, can be provided. In addition, a preferable wave absorber can be provided by this method.

This application is based on application Nos. 82744/2000 and 72656/2001 filed in Japan, the contents of which are incorporated hereinto by reference.

What is claimed is:

1. A wave absorber comprising a substrate and a wave absorptive layer comprising a binder and a particulate dielectric loss material, wherein said layer is formed on the substrate by rubbing a mixture of the particulate dielectric loss material and the binder in a solidifiable fluid state, and solidifying the binder.

2. The wave absorber of claim 1, wherein the mixture is rubbed on the substrate via an adhesive layer.

3. The wave absorber of claim 1, wherein the substrate comprises a convex thereon or a concave optionally penetrating the substrate, or both the convex and the concave, and the mixture is rubbed into the concave or to cover the convex.

4. The wave absorber of claim 1, wherein the substrate surface on which the mixture is rubbed is about planar.

5. The wave absorber of claim 1, wherein the mixture is rubbed on the substrate in not less than two layers, thereby forming a structure comprising two or more wave absorptive layers laminated on the substrate, and the kind or a mixing ratio of the dielectric loss material is determined such that the wave absorptive layer on the lower layer side can have a lower surface resistance than that of the wave absorptive layer on the upper layer side.

6. The wave absorber of claim 1, wherein the wave absorptive layer has a convex thereon or a concave or both the convex and the concave.

7. A wave absorber having a structure comprising a substrate and a wave absorptive layer laminated on the substrate, which layer comprising a particulate dielectric loss material fixed by a binder, wherein the substrate comprises a convex having a shape capable of holding the wave absorptive layer and suppressing release thereof, or a concave optionally penetrating the substrate, or both the convex and the concave, and the wave absorptive layer and the convex or the concave or both the convex and the concave are engaged with each other such that release from each other is suppressed.

8. A method for producing a wave absorber, which method comprises rubbing a mixture comprising a solidifiable fluid binder and a particulate dielectric loss material on a substrate and solidifying the binder, thereby to laminate a wave absorptive layer on the substrate.

9. The production method according to claim 8, wherein the substrate is a long belt-like plate.
